(19) United States
(12) Patent Application Publication
(10) Pub. No.: US 2003/0048873 A1
(43) Pub. Date: Mar. 13, 2003

(54) Method for improving a radiological examination and device therefor

(76) Inventors: Jean-Marc Dinten, Lyon (FR); Christine Robert-Coutant, St Martin D'Uriage (FR)

Correspondence Address: Thelen Reid & Priest, PO Box 640640, San Jose, CA, 95164-0640, US

(21) Appl. No.: 10/148,617

(22) PCT Filed: Dec. 1, 2000
(86) PCT No.: PCT/FR00/03357

(30) Foreign Application Priority Data
Dec. 3, 1999 (FR) 99/15273

(51) Int. Cl. H05G 1/44

(52) U.S. Cl. 378/108

(57) ABSTRACT

A process for improving a radiological examination and a device for implementing such a process.

According to the invention, before the examination by means of a radiological device (1) , a radioscopic image is taken of the area of the body to be examined (1c) and this image is used to determine first characteristic points, which define a measurement reference system, and geometric parameters of a movement able to make this measurement reference system correspond approximately with a reference system preset from equivalent characteristic points or to control the X-ray dose to be transmitted to the body during the examination. The invention applies particularly to osteodensitometry by dual energy cone beam X-ray radiation.

### TECHNICAL FIELD

The present invention relates to a process for improving a radiological examination of an area of a body and a device for implementing this process.

By “body” is meant both an object (for example a painting or a mummy) and a person or even an animal.

The invention applies to any radiological examination using a two-dimensional X-ray detector and, particularly, to osteodensitometry by dual energy cone beam X-ray radiation.

The invention relates more particularly to the positioning of a patient prior to such a radiological examination and to the control of the X-ray dose to be transmitted to this patient during this examination.

### PRIOR ART

It will be recalled that osteodensitometry by X-rays is a technique for measuring bone mass and density from radiographic acquisitions made with a plurality of energies.

Generally two energies are used which are called “high energy” and “low-energy” respectively.

Three families of osteodensitometry systems may be distinguished:

pencil beam systems which use an X-ray source collimated via a hole and a single x-ray detector which is also collimated,

fan beam systems which use an X-ray source collimated via a slit and a linear X-ray detector, and

cone beam systems which use an uncollimated X-ray source and a two-dimensional X-ray detector.

The systems of the two first families require a mechanical scan to obtain an overall image of an anatomical area whereas the systems in the third family allow a complete image to be established directly.

This is why the invention relates more particularly to dual energy cone beam X-ray osteodensitometry systems.

The methodological principles of osteodensitometry by dual energy X-ray and the principal currently used technical solutions are known through the two following documents to which reference will be made:

[1] “Technical Principles of Dual Energy X-ray Absorptiometry”, G. M. Blake and I. Fogelman, Seminars in Nuclear Medecine, Vol. XXVII, no. 3, July 1997, pages 210 to 228 and

[2] “The Evaluation of Osteoporosis: Dual Energy X-ray Absorptiometry and Ultrasound in Clinical Practice”, Second Edition, G. M. Blake, H. W. Wahner and I. Fogelman, Martin Dunitz Editor, 1999, IWSBN 1-85317-472-6.

Reference will be made more particularly to chapters 3, 4 and 5 of document (2) in which the principles of measuring bone density with two energies and the known systems for making such measurements are described.

Two-dimensional area osteodensitometry systems are also known through the following documents to which reference will be made:

[3] The U.S. Pat. No. 5,150,394 of the Sep. 22, 1992, “Dual-Energy System for Quantitative Radiographic Imaging”, (Andrew Karellas), and

[4] The international application published on Nov. 14, 1986, publication no. WO 96/35372, “A System for Quantitative Radiographic Imaging”, (Andrew Karellas”.

The following additional details are given:

In relation to patient positioning, in systems of the “pencil beam” or “fan beam” type, the patient is firstly positioned by means of a laser pointer which identifies the examination area from external morphological observations. Then X-ray scanning begins. If the patient is properly positioned the examination continues but if from observation on the screen of the first acquired lines the position is not right, the operator stops everything and repositions then restarts the examination.

Reference may be made on this matter to document [2] pages 198 to 200 in relation to the spinal column and to pages 265 to 267 in relation to the hip.

A recent study has shown that, for systems of the “pencil beam” type, repositioning occurred in 50% of cases and that, for about 10% of examinations, the patient had to be repositioned up to three times. Reference may be made on this matter to the following document:

[5] Insights, vol. 10, no. 1, March 1999, pp 10 and 11 (Journal published by the Hologic company), “Independent survey reveals surprising, disappointing results for Lunar users”.

In known systems of the “cone beam” type, used for examining peripheral areas, the patient is positioned using a mechanical positioning aid system, for example a grip for the fore-arm and a shaped bowl for the heel.

Additionally the possibility is already known of using an image prior to the examination to obtain prescan scout data to “centre” the patient, in the field of tomography, through the following patent:

[6] U.S. Pat. No. 5,457,724 “Automatic field of view and patient centering determination from prescan scout data” dated Oct. 10, 1995.

In this patent U.S. Pat. No. 5,457,724, before reconstructing a tomographic cross-section of a patient, two one-dimensional projections (using a fan beam) are acquired at 0° degrees and 90° of this cross-section. The points corresponding to the edges of the patient in the two projections are detected, and from them is deduced the area centre position and the tomographic acquisition field size. These parameters are given to the operator and may be used to move the patient in order to centre him better for the tomographic acquisition.

The purpose is to obtain the best possible quality of reconstructed image. Indeed, as tomographic systems are studied so that maximum attenuation is found at the centre of the acquisition area and as corrections of spectrum hardening depend on the acquisition field size, the quality of the reconstructed image depends on proper centring and on the acquisition field size.

### DISCLOSURE OF THE INVENTION

Generally speaking, the purpose of the present invention is to improve the reproducibility of measurements taken during any radiological examination which uses a two-dimensional detector.

Another purpose of the invention is to optimise the X-ray dose transmitted to the patient during such an examination.

The particular purpose of the present invention is to improve an osteodensitometry examination by dual energy code beam X-ray and, more particularly, to increase the reproducibility of bone density measurements in anatomical areas of a patient undergoing such an examination.

The precise objective of the present invention is a process to improve a radiological examination of an area of a body, this radiological examination being conducted using a radiological device, this process being characterised in that, before the radiological examination, a two-dimensional radioscopic image (therefore with a low X-ray dose) is taken, with a single energy for these X-rays, of the area of the body to be examined and this image is used to determine first characteristic points which define a measurement reference system, and geometric parameters of a movement able to make this measurement reference system correspond approximately with a reference system preset from equivalent characteristic points corresponding to the first characteristic points, or this image is used to control the X-Ray dose to be transmitted to the body during the radiological examination.

This radiological examination may be an osteodensitometry examination.

It is specified that the first characteristic points are generally points of the image which may be exactly identified, for example, contour points, inflection points or extreme density points.

According to a particular embodiment of the process which is the objective of the invention, when the radiological examination is a first examination, the pre-set reference system is a theoretical reference system, adapted to the body being examined.

According to another particular embodiment, when the radiological examination follows a previous radiological examination, conducted using the same radiological device, the pre-set reference system is a reference system which is defined on a previous image from the equivalent characteristic points.

In accordance with the present invention, the two-dimensional image may be used (on its own or additionally) to control the X-ray dose to be transmitted to the body during the radiological examination by adapting the operating point of the radiological device to the morphology of the body being examined or by setting the area to be irradiated by X-rays during the examination to the morphology of the body to be examined.

The present invention additionally relates to a radiological device for implementing the process which is the objective of the invention, this device including:

an X-ray source, able to supply an X-ray cone beam with at least one energy,

means of varying the X-ray dose able to be received by the body to be examined,

a two-dimensional X-ray detector, which is arranged parallel to a plane defined by two orthogonal directions and which is perpendicular to the axis of the X-ray beam,

means of supporting the body to be examined, these support means being transparent to the X-rays emitted by the source, arranged between the source and the detector and able to withstand a relative movement in relation to the unit formed by the source and the detector, along the two orthogonal directions,

means of determining first characteristic points on a two-dimensional radioscopic image, these first points defining a measurement reference system, and

calculation means, provided to determine the geometric parameters of a movement able to make this measurement system correspond approximately with a reference system pre-set from equivalent characteristic points corresponding to the first characteristic points.

### BRIEF DESCRIPTION OF THE DRAWINGS

The present invention will be better understood from reading the description of embodiment examples given below, purely by way of illustration and in no way restrictively, with reference to the appended drawings in which:

FIG. 1 is a diagrammatic view of a bone osteodensitometry system by dual energy, cone beam X-ray, which may be used to implement the invention, and

FIG. 2 is a flow chart of a procedure which is used in an particular embodiment of the invention.

### DETAILED DISCLOSURE OF PARTICULAR EMBODIMENTS

A description will now be given of an example of the process according to the invention, in relation to the positioning a patient before an examination of an anatomical area of the latter by dual energy cone beam X-ray osteodensitometry.

In this example, before making the acquisitions with high and low energies, the two-dimensional radioscopic image is taken with a single energy low X-ray dose of the anatomical area of the patient.

Next, from a detection of characteristic points defined from the bone contours on this image, the geometric parameters are deduced of a movement allowing a reference system defined by the characteristic points to be made to correspond as well as possible

either with a “theoretical” reference system defined by equivalent points, chosen in advance as a function of the anatomical area under consideration, in the case of a first examination,

or with a reference system defined by equivalent points, chosen on a previous two-dimensional image, in the case of an n^{th} examination with n>1.

In both cases, a patient is moved relative to the source-detector system, which makes up the osteodensitometry device, or the source-detector system is moved relative to the patient, by a manual or automatic control.

It should also be stated that in the present invention we are dealing with radiology (with a two-dimensional detector) and not with tomography (with a detector for a fan beam, driven by a rotation movement as is described in the document [6] mentioned above) The final image is a two-dimensional projection and not a reconstructed cross-section. Moreover, in the invention, a single previous image is used and not two images at 90 degrees to each other.

Additionally, a purpose of the example under consideration of the invention is the reproducibility of the bone mass measurement calculated from the image, and not the quality of the image itself.

Moreover, in tomographic systems re-centring the patient is not automatic.

More exactly this re-centring is automatic in height, in other words perpendicular to the plane of the table supporting the patient or parallel to the axis of the X-ray beam, but it is not automatic in width, in other words along the smallest dimension of this table, since lateral movement of the table is not envisaged or is not necessary.

Let us remind ourselves that reproducibility is the property, which the measurement device has, of giving the same measurement for different examinations on the same patient (presumed of constant bone density) and the same anatomical area.

In the case of a patient whose bone mass varies in time, under the effect of an illness or of treatment for example, this property of reproducibility makes it possible to quantify these variations in bone mass.

Moreover, in the present invention, the radioscopic image may be used to

1/adapt the radiation dose by controlling the X-ray flux by modifying the current applied to the X-ray tube being used and/or the voltage applied to this tube

2/automatically position masks making it possible to limit the radiation area, which is not possible in tomography at the risk of truncated projections.

In this way the radiation dose received by the patient is minimised.

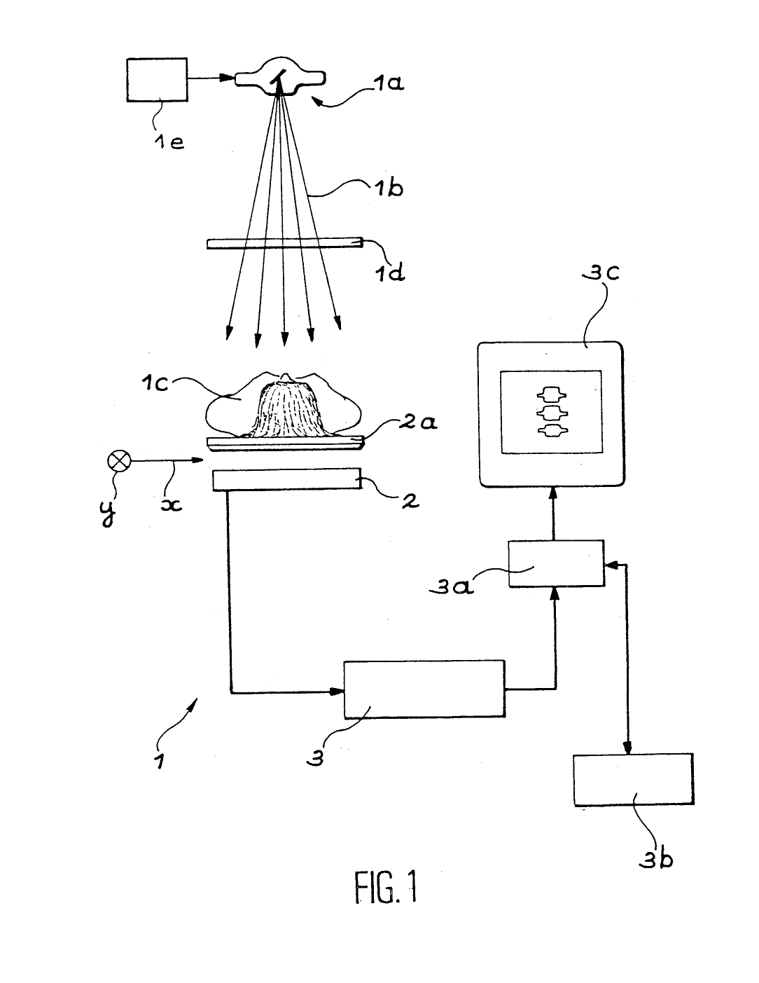

In FIG. 1 may be seen a bone osteodensitometry system 1 which is also used to make the previous radioscopic image in accordance with the invention.

This system includes an X-ray source 1a, able to send an X-ray cone beam 1b towards the body of a patient 1c to be examined. This source 1a is able to emit X-rays corresponding to two distinct energy levels respectively. These two levels are used to obtain two distinct images of the patient.

A detachable filter 1d may be interposed between the source 1a and the patient 1c and serves to improve the spectral qualities of the beam.

The system 1 also includes a two-dimensional detector 2 which is very diagrammatically shown in transverse cross-section in FIG. 1 and intended to detect the X-rays emitted by the source and which have passed through the patient 1c.

This detector 2 is parallel to a plane defined by two orthogonal directions x and y and is perpendicular to the axis of the X-ray beam.

The patient is placed on an appropriate support 2a, for example a bed, which is transparent to X-rays. In the example in FIG. 1 the source 1a (fitted with the possible filter 1d) is placed above the patient lying on the support while the detector is placed underneath this support.

Means not shown are provided to move the support 2a relative to the source 1a and to the detector 2, which are then fixed, or are provided to move the source 1a and the detector 2 relative to the support 2a which is then fixed, these movements occurring parallel to the directions x and y.

In the invention any type of two-dimensional detector may be used, for example a sensor sensitive to X-rays and able to provide directly an electronic signal representing the image acquired by the detector in the form of pixels.

Instead of this, a scintillator screen may be used which is provided to receive the X-rays, which have passed through the patient, and to convert these X-rays into visible light. This is then sent, via a mirror, to a CCD sensor equipped with a lens and including a network of photosensitive pixels.

In FIG. 1 may also be seen a device 3 of the CCD controller type or the like which reads, pixel by pixel, the image representation provided by the detector and which digitises this representation. The representation so digitised is stored in a memory 3a.

A computer 3b is provided to process the images so stored.

A display device 3c, including for example a cathode ray tube, is provided to display the images before or after this processing.

Such a system may therefore be used to implement a process in accordance with the invention, according to which, for the purpose of obtaining good reproducibility of bone density measurement, a first low dose image of the radioscopy type is used to help to position the patient in the osteodensitometry system.

Let us return to the use of this radioscopic image in respect of positioning the patient.

Considering that, for a system of the “cone beam” type, we have a two-dimensional sensor which makes it possible, in a single acquisition, to have an overall view of the area being analysed, it is proposed, in accordance with the invention, to make a low dose image (radioscopic image) before the high and low energy acquisitions in order to help to position the patient.

If this patient is undergoing his first examination, this radioscopic image is used to have a retroactive effect on the mechanics of the system (in other words to control the mechanics of the image acquisition device in such a way that it positions itself correctly relative to the patient or conversely) in order to position the anatomical area relative to a pre-set reference system.

If the examination is a follow-up examination of the patient, the radioscopic image is used to bring the anatomical area into a position identical to that which it occupied during the previous examination.

This type of operation makes it possible to increase appreciably the reproducibility of measurements taken using systems of the “cone beam” type.

Because of the X-ray beam taper, measurement depends on the position of the anatomical area in this beam.

Using the radioscopic image to position the anatomical area of the patient in an identical way relative to a given reference system or to ensure consistency between two examinations, good examination reproducibility is obtained.

One example of implementation for a patient undergoing their first examination consists in:

1. making a low dose image;

2. extracting the bone area contours from this acquisition, the contours being extracted using software identifying the points of maximum gradient (or nil Laplatian);

3. identifying characteristic points (these characteristic points being for example points of pronounced curvature, inflection points or intersection points) in the contour map, for example identifying vertebrae or identifying characteristic points on the neck of the thighbone, the characteristic points being identified by conventional image processing software;

4. constructing the translation type function which makes it possible to place these points as well as possible relative to a predefined standard position, with software setting (for example by a method of least squares) the parameters of a translation allowing the characteristic points to be brought back to a standard position;

5. having a retroactive effect on the positioning mechanics so as to return to the standard position;

6. making the acquisitions.

In the case of a patient undergoing a therapeutic follow-up examination the function 4 construction step is replaced by the following two steps:

4.1 recovering the positions of the characteristic points in the acquisitions of a previous examination of the patient;

4.2 constructing the translation type function which allows the characteristic points of the scopic image to be brought into correspondence as well as possible relative to their position in a previous examination.

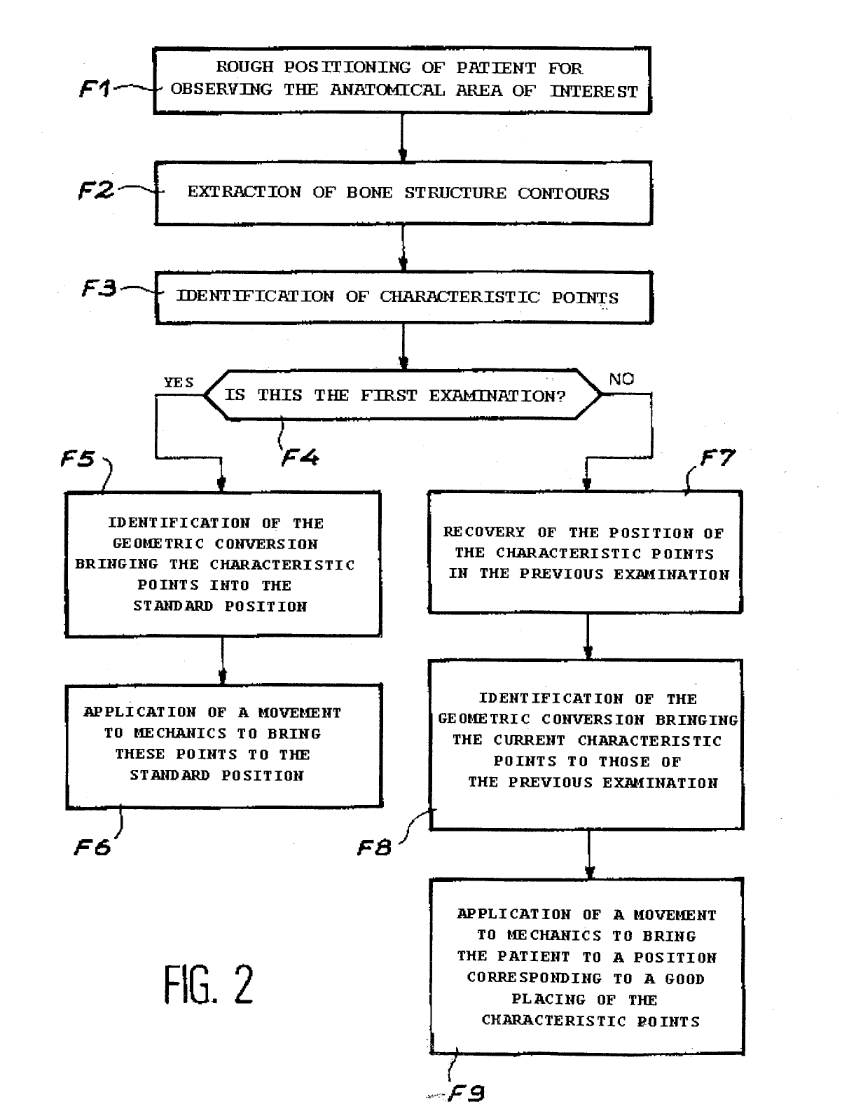

All this is made clear in the flow chart in FIG. 2:

Step F1: the patient is roughly positioned so as to observe the anatomical area of interest (see 1.)

Step F2: the bone structure contours are extracted (see 2.)

Step F3: the characteristic points are identified (see 3.)

Step F4: the question is asked as to whether this is the first examination

If the answer is yes go to step F5 in which the geometric conversion is identified bringing the characteristic points into the standard position (see 4.) then go to step F6 in which a movement is applied to the mechanics to bring these points to the standard position (see 5.)

If the answer is no go to step F7 in which the position of the characteristic points in the previous examination (see 4.1) is recovered then go to step F8 in which the geometric conversion is identified bringing the current characteristic points to those of the previous examination (see 4.2) then go to step F9 in which a movement is applied to the mechanics so as to bring the patient to a position corresponding to a good placing of the characteristic points (see 5.).

Let us return to the device in FIG. 1. It is stated that the X-ray area 1a is equipped with control means allowing it to vary the X-ray dose transmitted to the patient 1c.

To make the radioscopic image these means 1e are set in such a way that the source sends a low dose to the patient, for example a dose equal to 1 μSv.

Moreover, the source 1a is capable of emitting low energy X-rays and high-energy X-rays.

To make the radioscopic image, an X-ray beam is used which produces a good image contrast and a minimum dose for the body being examined, with an energy for example equal to 80 keV.

The radioscopic image may be used not only to position the patient before his examination but also to optimise the X-ray dose, which will be transmitted to the patient during his examination.

For this optimisation, the operating point of the source is adapted to the morphology (particularly the thickness) of the patient. In this case the scopic image is used to determine the order of magnitude of the thickness of the body being displayed.

As a variant, to optimise the X-ray dose which will be transmitted to the patient during his/her examination, the X-ray radiation area is adjusted to the morphology of the patient. In this case, the radioscopic image is used to determine the bone area and the tissue area around this bone area.

The invention is not limited to improving an osteodensitometry examination. It applies to any other radiological examination using a two-dimensional detector, for example a bone fracture consolidation follow-up examination.

Moreover, the invention is not limited to the improvement of the radiological examination of a patient. It may be implemented with any living or inert body, for example a painting, before this painting undergoes radiography.

1. A process for improving a radiological examination of an area of a body (1c), this examination being conducted using a radiological device (1) , this process being characterised in that, prior to the radiological examination, a two-dimensional radioscopic image is taken, with a single energy for the X-rays used, of the area of the body to be examined and this image is used to determine first characteristic points which define a measurement reference system, and geometric parameters of a movement able to make this measurement reference system correspond approximately with a reference system pre-set from equivalent characteristic points corresponding to the first characteristic points, or this image is used to control the X-Ray dose to be transmitted to the body during the radiological examination.

2. A process according to claim 1, wherein the radiological examination is an osteodensitometry examination.

3. A process according to any one of claims 1 and 2, wherein the radiological examination is a first radiological examination and the pre-set reference system is a theoretical reference system, adapted to the body being examined.

4. A process according to any one of claims 1 and 2, wherein the radiological examination follows a previous radiological examination, conducted using the same radiological device (1), and the pre-set reference system is a reference system, which is defined on a previous image from the equivalent characteristic points.

5. A process according to any one of claims 1 to 4, wherein the X-ray dose to be transmitted to the body (1c) is controlled during the radiological examination, by adapting the operating point of the radiological device (1) to the morphology of the body being examined.

6. A process according to any one of claims 1 to 4, wherein the X-ray dose to be transmitted to the body (1c) is controlled during the radiological examination, by setting the area to be irradiated by X-rays during the examination to the morphology of the body to be examined.

7. A radiological device for implementing the process according to claim 1, this device (1) including:
an X-ray source (1a), able to supply an X-ray cone beam with at least one energy,
means (1e) of varying the X-ray dose able to be received by the body to be examined,
a two-dimensional X-ray detector (2), which is arranged parallel to a plane defined by two orthogonal directions (x, y) and which is perpendicular to the axis of the X-ray beam,
means (2a) of supporting the body to be examined, these support means being transparent to the X-rays emitted by the source, arranged between the source and the detector and able to withstand a relative movement in relation to the unit formed by the source and the detector, along the two orthogonal directions,
means of determining first characteristic points on a two-dimensional radioscopic image, these first points defining a measurement reference system, and
calculation means, provided to determine the geometric parameters of a movement able to make this measurement system correspond approximately with a reference system pre-set from equivalent characteristic points corresponding to the first characteristic points.
